(19) United States
(12) Patent Application Publication
(10) Pub. No.: US 2007/0151855 A1
(43) Pub. Date: Jul. 5, 2007

(54) Microfluidic system and associated operational method

(75) Inventors: Thomas Schnelle, Berlin (DE); Torsten Muller, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: EVOTEC TECHNOLOGIES GMBH, Dusseldorf (DE)

(21) Appl. No.: 10/597,696

(22) PCT Filed: Feb. 3, 2005
(86) PCT No.: PCT/EP05/01085

§ 371 Date: Aug. 3, 2006

(30) Foreign Application Priority Data
Apr. 8, 2004 (DE) 10 2004 017 481.4
Feb. 4, 2004 (EP) PCT/EP04/01031
Feb. 4, 2004 (EP) PCT/EP04/01034

(51) Int. Cl. B03C 5/02

(52) U.S. Cl. 204/547; 204/643

(57) ABSTRACT

The invention relates to a microfluidic system, in particular in a cell sorter, including a first carrier power supply (1) which is used to supply a first carrier flow having particles (4) suspended therein, a first carrier power output line (15) which is used to withdraw at least one part of the carrier flow having particles (4) suspended therein, a process chamber (3) which is used to examine, observe, manipulate and/or select the particle (4). The first carrier power supply (1) flows into the process chamber (3) when the first carrier power output line (15) is discharged from the process chamber (3). According to the invention, at least one second carrier power supply (2) flows into the process chamber (3) in order to supply a second carrier flow having particles (5) suspended therein. The invention also relates to a corresponding operational method.

The invention relates to a microfluidic system, in particular for a cell sorter, as well as to an associated operational method.

An examining process for biological cells is known from MÜLLER, T. et al.: “A 3-D Microelectrode system for Handling and Caging Single Cells and Particles”, Biosensors and Bioelectronics 14 (1999), 247-256 in which the cells to be examined are suspended in a carrier flow of a microfluidic system and dielectrophoretically manipulated and sorted. The cells to be examined are first aligned in the carrier flow by a funnel-shaped dielectrophoretic electrode arrangement (funnel) and subsequently retained in a dielectrophoretic cage in order to be able to examine the cells located in the cage in a resting state, for which microscopic, spectroscopic or fluorescence optical measuring methods can be used. The cells trapped in the dielectrophoretic cage can be subsequently sorted as a function of their being examined, to which end the user controls a sorting device consisting of a dielectrophoretic electrode arrangement arranged in the carrier flow downstream behind the dielectrophoretic cage.

This known microfluidic system has the disadvantage that in order to examine and sort different particle types separate series of examination are necessary between which the microfluidic system must as a rule even be rinsed in order to eliminate particle residues of the previous examination series.

The invention therefore has the objective of creating a possibility of examining different particle types in one microfluidic system as simple as possible.

This objective is solved by the features of the independent claims.

The invention comprises the general technical teaching for providing a microfluidic system with at least two carrier flow supply lines via which the carrier flows with particles suspended therein can be introduced into a process chamber in which the particles can be subjected to an examination, observation, manipulation and/or selection. This offers the advantage that different particle types can be examined within the framework of a single examination without an intermediate rinsing of the microfluidic system.

Thus, all carrier flows in the individual carrier flow supply lines preferably contain suspended particles that can then be examined, observed, manipulated and/or selected in the process chamber. This is to be distinguished from microfluidic systems in which several carrier flows are also supplied but only a single carrier flow contains the particles of interest (e.g., biological cells) whereas the other carrier flows contain, e.g., a candidate compound (e.g., a cell activator) that reacts with the particles.

In a preferred embodiment of the invention two carrier flow supply lines open into the process chamber so that two different carrier flows with different particles suspended therein can be introduced into the process chamber.

However, the invention is not limited as regards the number of carrier flow supply lines to two carrier flow supply lines but rather a greater number of carrier flow supply lines is also possible if a greater number of particle types is to be examined within the framework of a single examination series.

The individual carrier flow supply lines can both be angled to the carrier flow output line in the microfluidic system of the invention, wherein the individual carrier flow supply lines can have the same inflow angle relative to the carrier flow output line.

However, there is the alternative possibility that the carrier flow output line or the canal-shaped process chamber forms a prolongation of one of the carrier flow supply lines so that the other carrier flow supply line flows into a continuous canal.

The inflow angle of the carrier flow supply lines can basically have any value greater than 0° and less than 180°, any intermediate values being possible. However, the carrier flow supply lines preferably open at an acute angle into the process chamber and into the carrier flow output line, that is, with an inflow angle greater than 0° and less than 90°, 60°, 50°, 40°, 30° or even less than 20°.

Moreover, the individual carrier flow supply lines open preferably at the same location into the process chamber. This means that the mouths of the individual carrier flow supply lines are not offset in the direction of flow.

However, there is also the alternative possibility that the individual carrier flow supply lines open into the process chamber one behind the other in the direction of flow so that the mouths of the individual carrier flow supply lines are arranged offset in the direction of flow.

However, the process chamber does not necessarily have to be canal-shaped in the framework of the invention. It is also possible, for example, that the carrier flow supply lines and/or the carrier flow output lines empty in a star shape into the process chamber in the microfluidic system of the invention.

A measuring station is preferably provided for examining the particles suspended in the individual carrier flows, wherein the individual measuring stations can be arranged in the separate carrier flow supply lines. However, the individual measuring stations for the various particles are preferably arranged in the common process chamber, wherein a separate examination of the individual particles is made possible in that the individual carrier flows supplied run adjacent to each other in the process chamber at least in an examination area situated upstream inside the process chamber without being substantially mixed with each other.

For example, the two carrier flow supply lines can run in a y shape into the common process chamber where they run adjacent to one another at first. The first measuring station is then arranged in the examination area of the process chamber in the area of the first carrier flow whereas the second measuring station is arranged in the examination area of the process chamber in the area of the second carrier flow and adjacent to the first measuring station as regards the direction of flow.

In order to avoid a mixing of the two carrier flows in the upstream examination area of the process chamber an optional dividing wall is provided between the two carrier flows in a preferred exemplary embodiment of the invention, the dividing wall being impermeable for the particles. The dividing wall is also preferably impermeable for the carrier flows but it is also conceivable that the dividing wall is impermeable only for the particles put on the other hand the dividing wall is permeable for the carrier flows.

Even without a dividing wall in the process chamber the microfluidic system of the invention is preferably designed in such a manner that the individual carrier flows do not mix or only mix to a negligible extent with each other in the process chamber. This can be achieved by a laminar flow into the process chamber.

Furthermore, at least one dielectrophoretic field cage is arranged in the common process chamber in order to fix the particles. There is also the possibility of arranging a field cage in each carrier flow in the process chamber, which makes a parallelizing possible. However, it is also possible that the already mentioned measuring stations are designed as a field cage and a fixing, sorting, etc. can also take place with them.

A fixing of the particles in the field cage is, e.g., advantageous since the particles can be better examined in the fixed state, to which end a third measuring station is preferably provided that examines the particles fixed in the field cage. The design and the manner of functioning of a field cage is described, e.g., in the initially already cited publication of MÜLLER, T. et al.: “A 3-D Microelectrode system for Handling and Caging Single Cells and Particles”, so that the content of this publication is to be added to its full extent to the present description. However the concept of a field cage used in the framework of the invention is to be understood in a general manner and not limited to the known constructive designs of field cages but rather the concept of a field cage in the sense of the invention comprises all dielectrophoretic holding elements such as, e.g., also a so-called “hook”.

In a preferred exemplary embodiment of the invention the field cage is arranged in the process chamber substantially in the middle between the two carrier flows relative to the direction of flow. Without an external control the particles suspended in the two carrier flows therefore flow laterally past the field cage and are not fixed by it.

Therefore, a selection unit is preferably arranged between the two measuring stations for the examination of the various particles and between the field cage, which selection unit selects certain particles from the first carrier flow and/or from the second carrier flow and supplies them to the field cage so that it can fix the particles. The selection unit preferably comprises a dielectrophoretic electrode arrangement like the one described in the initially already cited publication by MÜLLER, T. et al.: “A 3-D Microelectrode system for Handling and Caging Single Cells and Particles”, where it is designated as a “funnel”. However, the invention is not limited as regards the design of the selection unit to this known construction principle.

It should furthermore be mentioned that the selection unit can select the particles suspended in the first carrier flow and the particles suspended in the second carrier flow preferably independently of each other and supply them to the field cage. The selection unit can also selectively select the particles suspended in the first carrier flow or the particles suspended in the second carrier flow and supply them to the field cage. The selection of the particles to be selected can takes place as a function of the examination result in the two measuring stations. For example, a particle suspended in the first carrier flow can be selected and supplied to the field cage if the previous examination in the first measuring station yielded a certain examination result. Correspondingly, a particle suspended in the second carrier flow can be selected and supplied to the field cage if the previous examination of this particle in the second measuring station yielded a certain examination result.

However, it is also possible in the framework of the invention that the particles suspended in the two carrier flows are selected in common and brought together for pair formation in the field cage.

Furthermore, a centering unit can be arranged in the process chamber and/or in one or several carrier flow output lines that centers the particles suspended in the carrier flow. In this manner a depositing and adhering of particles to the inner wall of the carrier flow supply lines, of the processing chamber and/or of the carrier flow output line is advantageously prevented. Such a centering unit advantageously has a dielectrophoretic electrode arrangement such as described, e.g., in the initially already mentioned publication of MÜLLER, T. et al.: “A 3-D Microelectrode system for Handling and Caging Single Cells and Particles”, where it is designated as a “funnel”. The content of this publication is therefore to be added to the present description as regards the construction of the centering unit.

Moreover, a holding unit can also be arranged in one or more carrier flow supply lines, in the process chamber or in one or more output lines that temporarily holds the particles suspended in the carrier flow. Such a holding unit can then always hold a certain supply of particles available at the input of the microfluidic system of the invention. At the output of the microfluidic system such a holding unit makes possible a temporary fixing of the particles, which can be significant, e.g., in a batch operation in which the desired particles are collected and then transported further in common. Such a holding unit preferably comprises a dielectrophoretic electrode arrangement that is known and is customarily designated as a “hook”.

Furthermore, several carrier flow output lines are preferably discharged out of the process chamber, wherein the particles can be sorted onto the various carrier flow output lines. To this end a sorting unit is preferably provided that is preferably arranged in the downstream area of the process chamber and performs the sorting onto the various carrier flow output lines. The sorting unit preferably has a dielectrophoretic electrode arrangement like the one described, e.g., in the initially already cited publication of MÜLLER, T. et al.: “A 3-D Microelectrode system for Handling and Caging Single Cells and Particles”, where it is designated as a “switch”. However, the invention is not limited as regards the design and the mode of operation of the sorting unit to this known construction principle.

The control of the sorting unit for sorting the particles onto the various carrier flow output lines preferably takes place as a function of the examination of the particles in the process chamber. The sorting can take place exclusively as a function of the examination of the particles fixed in the field cage. However, it is also possible that the sorting only takes place as a function of the examination of the particles in the separate carrier flows. Furthermore, the sorting can also take place as a function of all examinations carried out in the process chamber.

One of the carrier flow output lines is preferably discharged in a flow line behind the field cage out of the process chamber so that the particles released from the field cage are discharged without an active control of the sorting unit via this carrier flow output line. On the other hand, the other carrier flow output lines are preferably discharged in a laterally offset manner opposite the flow line behind the field cage out of the process chamber so that an active control of the sorting unit is required in order to withdraw the particles released from the field cage via this laterally offset carrier flow output line.

The carrier flow output line discharged in the flow line behind the field cage is preferably used for withdrawing such particles that frequently occur in the carrier flows whereas, on the contrary, the laterally offset carrier flow output lines are preferably used to withdraw particles that occur less frequently in the carrier flows. This is advantageous because the sorting unit needs to be actively controlled less frequently in this manner.

Furthermore, it should be mentioned that the invention comprises not only the previously described microfluidic system as an individual part such as, e.g., a chip, but rather also relates to a cell sorter and a cell fusioner with such a microfluidic system.

In order to avoid repetitions, refer for the details of cell fusion to patent application DE 198 59 459 A1; the content of this patent application relating to cell fusion is to be introduced into the present description.

In a variant of the invention at first a cell fusion and subsequently an examination of the cell pair produced take place in the microfluidic system of the invention. Then, a sorting onto one of several output lines takes place as a function of the result of this examination.

In addition, the invention also comprises a corresponding operational method that has already been described above.

Furthermore, it should be mentioned that the concept of a particle used in the framework of the invention is to be understood in a general manner and is not limited to individual biological cells but rather this concept also comprises synthetic or biological particles, special advantages resulting if the particles comprise biological materials, that is, e.g., biological cells, cell groups, cell components, viruses or biologically relevant macromolecules, optionally in a composite with other biological particles or synthetic carrier particles. Synthetic particles can comprise solid particles, liquid particles separated off from the suspension medium or multiphase particles that form a separate phase opposite the suspension medium in the carrier flow.

Furthermore, the concept of a microfluidic system used in the framework of the invention is to be understood in a general manner and preferably means that the dimensions of the carrier flow supply lines, of the process chamber and of the carrier flow output lines are so small that the carrier flow is laminar without the formation of vortices. In addition, it should be mentioned that the width of the carrier flow supply lines, of the process chamber and of the carrier flow output lines is preferably in the range of a multiple (e.g., 10 to 400 times greater) of the particle diameter.

The dimensions (with, depth and/or diameter) of the carrier flow supply lines, the process chamber and/or the carrier flow output lines are preferably in a range of 50 nm to 2 mm, any desired intermediate values and partial ranges within this interval being possible.

The process chamber preferably has a length of the direction of flow that is in a range of 100 nm to 10 mm, any desired intermediate values and partial ranges within this interval being possible.

Other advantageous further developments of the invention are characterized in the dependent claims or are explained in detail in the following together with the description of the preferred exemplary embodiments of the invention using the figures.

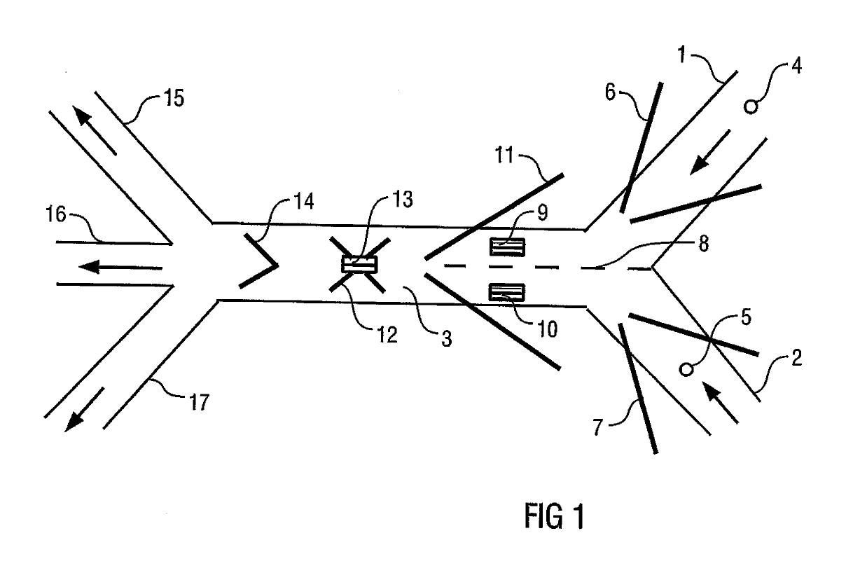

FIG. 1 shows an embodiment of a microfluidic system in accordance with the invention in a sorting chip of a cell sorter, and

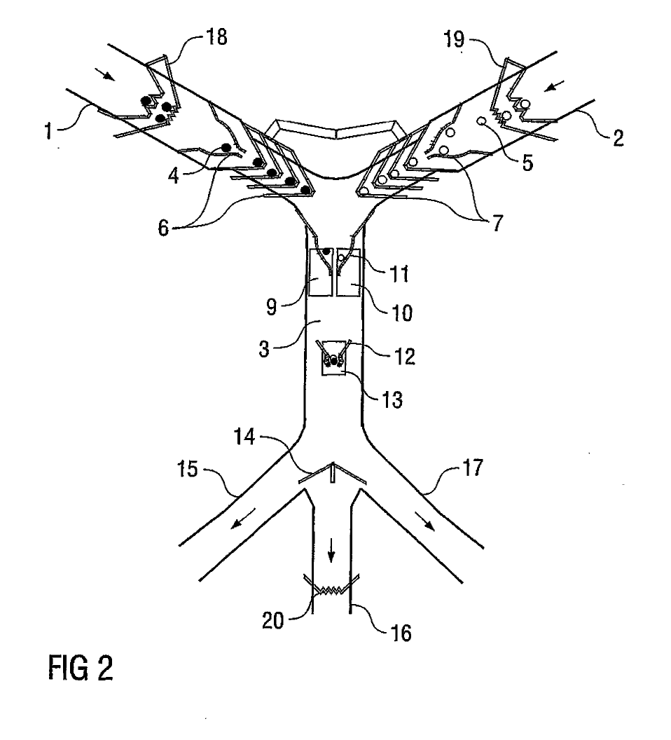

FIG. 2 shows an alternative embodiment of the microfluidic system in accordance with the invention for cell fusion.

In the embodiment according to FIG. 1 two carrier flow supply lines 1, 2 open into a process chamber 3, suspended particles 4, 5 being supplied via the two carrier flow supply lines 1,2.

A funnel-shaped electrode arrangement 6, 7 is arranged in each of the two carrier flow supply lines 1, 2 in order to center the particles, 4, 5 suspended in the carrier flows of the two carrier flow supply lines 1, 2. The construction and the mode of operation of the electrode arrangements 6, 7 is known and described, e.g., in the initially already cited publication MÜLLER, T. et al.: “A 3-D Microelectrode system for Handling and Caging Single Cells and Particles”.

A dividing wall 8 is optionally situated in the process chamber 3 in an upstream examination area at the mouth site of the two carrier flow supply lines 1, 2 so that the particles 4, 5 suspended in the carrier flows of the two carrier flow supply lines 1, 2 are first guided in the process chamber 3 in parallel adjacent to each other and separated from each other. The dividing wall 8 is therefore impermeable for the two carrier flows and for the particles 4, 5 suspended therein.

Two measuring stations 9, 10 are present in the process chamber 3 in the area of the dividing wall 8 in order to subject the suspended particles 4, 5 to a preliminary examination while they are flowing past. The preliminary examination can take place in a conventional manner and comprise, e.g., a transmitted-light measuring or a fluorescence optical examination.

A funnel-shaped electrode arrangement 11 is located downstream behind the two measuring stations 9, 10 in the process chamber 3 that centers the particles 4, 5 suspended in the two partial flows on each side of the dividing wall 8 and supply lines them to a dielectrophoretic field cage 12 that can fix the particles 4, 5 for an examination in another measuring station 13. The construction and the mode of operation of the electrode arrangement 11 is also known as such and is described in the initially already cited publication by MÜLLER, T. et al.: “A 3-D Microelectrode system for Handling and Caging Single Cells and Particles”. However, the electrode arrangement 11 has two legs in this embodiment that can be switched separately and independently of one another.

Furthermore, it should be mentioned that the examination in the measuring station 13 can also take place in a conventional manner and comprises, e.g., a transmitted-light measuring, a fluorescence measuring, an electrical measuring (e.g., impedance measuring) or a combination of several measurings.

The fixing of the particles 4, 5 in the field cage 12 is advantageous since the particles 4, 5 can be examined more precisely in the resting state.

Additionally, a retarding element (holding elements) can be arranged behind each of the two measuring stations 9, 10 and in front of the electrode arrangement 11, the two retarding elements not being shown in the drawings. The electrode arrangement 11 would only be controlled in this instance if the two retarding elements actually contain particles, whereas, on the other hand a control of the electrode arrangement is superfluous if no particles are present in the retarding elements.

If the particle 4 is positively evaluated in measuring station 9 and guided by the electrode arrangement 11 into the field cage 12 the entry electrodes (or, better said, the upstream electrodes) of the field cage 12 are switched off and the downstream electrodes switched on. The particle 4 is thus prevented by the switched-on electrodes from making a movement with the flow and is practically held. The upstream electrodes are also switched on only if the further particle 5 is deflected after a positive evaluation in the measuring station 10 by the electrode arrangement 11 into the field cage 12.

Alternatively, there is also the following possibility: All electrodes of the field cage 12 are switched on and form a barrier for the particle 4 that hinders the particle 4 from moving further. Only if the particle 5 has also been deflected in the direction of the field cage 12, all electrodes are briefly switched off so that both particles 4, 5 can pass into the field cage. They are switched on again immediately afterward.

Another electrode arrangement 14 is located downstream behind the dielectrophoretic field cage 12 that supplies the particles 4, 5 suspended in the carrier flow after being released by the field cage 12 as a function of the result of the examination in the measuring station 13 of one of three output lines 15, 16, 17.

The output lines 15, 17 serve to withdraw the negatively selected particles 4, 5 whereas the carrier flow output line 16 serves to conduct the positively selected particles further. The carrier flow output line 16 opens into the flow line behind the field cage 12 from the process chamber 3 whereas the output lines 15, 17 discharge from the processing chamber 3 in a laterally offset manner opposite the flow line behind the field cage 12. This has the consequence that the particles 4, 5 released by the field cage 12 pass without an external influence of force into the carrier flow output line 16. Therefore, the electrode arrangement 14 must be actively controlled if the particles 4, 5 are to be transported into the output lines 15, 17 for the negatively selected particles 4, 5, in contrast to which no control takes place for the positively selected particles 4, 5. Therefore, this arrangement is especially suited for such examinations in which only a few of the particles 4, 5 are negatively selected.

The embodiment of a microfluidic system in accordance with the invention shown in FIG. 2 agrees largely with the previously described embodiment so that the previous description is referred to by way of supplementation and in the following the same reference numerals are used for corresponding structural components.

This embodiment has the particularity that the particles 4, 5 can be effectively fusioned in the microfluidic system to aggregates, especially to hybrid pairs, and different types of particles 4, 5 can be supplied via the carrier flow supply lines 1, 2.

The field cage 12 is therefore designed somewhat differently in this embodiment and combines the functions of a centering unit (“Funnel”) and of a field cage.

Furthermore, the (multi-)electrode arrangements 6, 7 in the two carrier flow supply lines 1, 2 optionally consist here of several funnel-shaped and of several hook-shaped electrodes that can be galvanically connected to each other on at least one of the electrode planes and then controlled in common. This has the advantage that the number of electrical power lines can be reduced and ensures an improved centering and individualizing of the particles. The (multi-)electrode arrangements 6, 7 should be connected galvanically at the most in one electrode plane in order to be able to switch them independently in the two carrier flow supply lines 1, 2.

Furthermore, a holding unit 18, 19 is arranged in each of the two carrier flow supply lines 1, 2 upstream in front of the (multi-)electrode arrangements and consists of a dielectrophoretic electrode arrangement. The holding units 18, 19 can store the particles 4, 5 supplied via the carrier flow supply lines 1, 2 intermediately so that a sufficient but not too great number of the particles 4, 5 is always available for a pair formation at the input of the microfluidic system. The electrode arrangements of the two holding units 18, 19 consist of two zigzag-shaped electrodes arranged in series in the direction of flow. The two zigzag-shaped electrodes of the holding units 18, 19 can be galvanically connected to one another and controlled in common.

The holding unit 18 and the electrode arrangement 6 in the carrier flow supply line 1 are controlled here in a time-coordinated manner with the holding unit 19 and the electrode arrangement 7 in carrier flow supply line 2. It is ensured in this manner that a sufficient number of the particles 4, 5 of both types are always collected for the pair formation. Moreover, the time-coordinated control also prevents the particles 4, 5 from clumping together too greatly in an unsuitable cell concentration.

The particles 4, 5 are conducted by the funnel-shaped (multi-)electrode arrangements 6, 7 from the canal edges to the canal middle and also raised at the same time in the z-plane, which contributes to an improved particle flow and prevents cells and aggregates from readily adhering on the glass surface and resulting in a particle accumulation. The (multi-)electrode arrangements 6, 7 are arranged in such a manner here that both the particle flows do not mix with one another in an uncontrolled manner. Individual particles 4, 5 can be intermediately stored in the several hook-shaped electrodes of the (multi-)electrode arrangements 6, 7 and passed into the process chamber 3 in a controlled manner. This can be realized at a given flow rate by briefly switching off or switching over of the electrodes so that when the particles 4, 5 that are trapped the furthest downstream are released the other intermediately stored particles 4, 5 are stored again one position downstream. If this takes place correlated with the manipulation and/or detection that took place in the process chamber 3, an optimal supplying of the process chamber 3 with the particles 4, 5 and therewith a high throughput of the microsystem can be realized.

Furthermore, another holding unit 20 is arranged in the carrier flow output line 16 that also consists of a dielectrophoretic electrode arrangement and is designed similarly to the holding units 18, 19. The holding unit 20 makes it possible to retain a cell pair formed in the field cage 12 before being transmitted further in the carrier flow output line 16. This is especially advantageous in a batch operation of the microsystem.

The further operational method in the process chamber 3 of the microsystem shown in FIG. 2 will now be described.

Once the particles 4, 5 of the two cell types pass the measuring stations 9, 10 independently of one another, for example, their optical properties are registered (e.g., size, fluorescence, transmitted-light quality, phase contrast, individual/aggregate, interval to the next cell). Switching-on and switching-off of the field cage 12 is initiated via a trigger on the detection side.

If the particular particle 4, 5 does not meet the desired target criteria the legs of the funnel-shaped electrode arrangement 11, that are to be switched independently, are switched off and the negatively evaluated particle 4, 5 passes, after having passed electrode arrangement 14, into the output lines 15, 17. Alternatively, instead of the funnel-shaped electrode arrangement 11 (funnel) two so-called fast switches can be used. Such fast switches are known, e.g., from FIGS. 2 and 3 of the German Patent Application 10 2004 017 482, whose content is therefore to be introduced to its full extent into the present description.

The particularity of such fast switches is that the electrode arrangement has an arrow electrode that is aligned counter to the direction of flow and is permanently controlled, two deflection electrodes bordering on the arrow electrode that are controlled for deflection into the desired output line. This configuration is designated as an “ultra-fast sorter” (UFS) and makes possible a rapid sorting of the suspended particles 2.

If one of the particles 4, 5 has been positively evaluated the corresponding individual legs of the electrode arrangement 11 are switched on and the particle 4, 5 passes in front of the field cage 12 that serves for pair formation. This can be, instead of field cage 12, a so-called “hook” or a so-called “hollow chamber funnel” (even with several pockets, not shown here). This process is repeated after the release of the lacking particle 4 or 5 from the corresponding carrier flow supply line 1 and/or 2 until two particles 4, 5 stand ready in front of the field cage 12 that are subsequently trapped as a pair by a brief switchover or switching on and off of at least the upstream field cage electrodes in field cage 12. This can be followed by an additional manipulation. Thus, the particles 4, 5 can be pressed, e.g., sufficiently long or strongly against one another dielectrically in the field cage 12 so that they can form a fixed composite and/or be exposed to brief, high electrical direct voltage pulses. For example, biological cells can be fusioned in this manner. The composite formation can also be activated optically (e.g., photochemically or by so-called laser scalpels) and/or thermally (e.g., by applying an elevated cage voltage).

If it is ensured, e.g., by the optical detection that the pair formation took place, the cell pair can pass the system and is washed out in the middle carrier flow output line 16 or, in a batch processing, intermediately stored in the holding unit 20.

Otherwise, the middle carrier flow output line 16 is dielectrically closed by the blocking function of the arrow-shaped electrode arrangement 14.

It becomes more challenging if the two particles 4, 5 are to be purposefully combined in the field cage 12 only. This makes it possible, e.g., to allow all pairs of a batch to enter into contact with each other for a defined time span in order to realize, e.g., a reliable activation of the one particle type. In addition, this procedure makes a defined sequence of the particle aggregation possible in the case of more than two carrier flow supply lines. It is appropriate for particle combination in the field cage 12 to hold the particle 4, 5 in the switched-on field cage 12 after the positively evaluated particle 4, 5 has passed the funnel-shaped electrode arrangement 11. When the second particle 4, 5 comes in front of the field cage 12 the upstream electrodes of the field cage 12 are briefly switched over and/or switched off and then cut back in. The particle pair is then trapped. Alternatively, it is also possible to operate only the field cage 12 in the catch mode at first. In this instance the electrode pairs facing away from the flow are switched on and the areas located in the flow are switched off. One of the particles 4, 5 is held in the range of the cage. Not until the second particle 4, 5 passes into the central range of the field cage 12 is the side facing the flow also switched on via a trigger signal.

The invention is not limited to the previously described preferred exemplary embodiment but rather a plurality of variants and modifications are possible that also make use of the inventive concept and therefore fall into the scope of protection.

### LIST OF REFERENCE NUMERALS

1 carrier flow supply line
2 carrier flow supply line
3 process chamber
4 particle
5 particle
6 electrode arrangement
7 electrode arrangement
8 dividing wall
9 measuring station
10 measuring station
11 electrode arrangement
12 field cage
13 measuring station
14 electrode arrangement
15 carrier flow output line
16 carrier flow output line
17 carrier flow output line
18 holding unit
19 holding unit
20 holding unit

1-29. (canceled)

30. A microfluidic system, comprising:
a first carrier flow supply line for supplying a first carrier flow with particles suspended therein,
a first carrier flow output line for withdrawing at least a part of the first carrier flow with the particles suspended therein,
a second carrier flow supply line for supplying a second carrier flow with particles suspended therein, and
a process chamber for examining, observing, manipulating and/or selecting the particles, wherein the first carrier flow supply line and the second carrier flow supply line open into the process chamber, and the first carrier flow output line is discharged out of the process chamber.

31. The microfluidic system according to claim 30, further comprising:
a first measuring station for examining the particles suspended in the first carrier flow, and
a second measuring station for examining the particles suspended in the second carrier flow.

32. The microfluidic system according to claim 31, wherein the first carrier flow and the second carrier flow run adjacent to one another in the process chamber at least in an examination area located upstream.

33. The microfluidic system according to claim 31, wherein the first measuring station is arranged in an examination area of the process chamber in an area of the first carrier flow whereas the second measuring station is arranged in the examination area of the process chamber in an area of the second carrier flow and adjacent to the first measuring station as regards a direction of flow.

34. The microfluidic system according to claim 32, wherein a dividing wall is arranged in the examination area of the process chamber between the first carrier flow and the second carrier flow, the dividing wall being impermeable for the particles and/or for the carrier flows.

35. The microfluidic system according to claim 32, wherein a dielectrophoretic field cage is arranged in the process chamber in order to fix the particles.

36. The microfluidic system according to claim 35, wherein the field cage is arranged downstream behind the first measuring station and the second measuring station.

37. The microfluidic system according to claim 35, wherein the field cage is arranged in the process chamber substantially in the middle between the two carrier flows.

38. The microfluidic system according to claim 35, wherein a selection unit is arranged in the direction of flow between the measuring stations and the field cage that selects certain particles from the first carrier flow and/or from the second carrier flow and supply lines them to the field cage.

39. The microfluidic system according to claim 35, further comprising a third measuring station for examining the particles fixed in the field cage.

40. The microfluidic system according to claim 30, wherein at least one centering unit that centers the particles is arranged in the first carrier flow supply line and/or in the second carrier flow supply line and/or in the process chamber.

41. The microfluidic system according to claim 30, wherein at least one holding unit that holds the particles is arranged in the first carrier flow supply line and/or in the second carrier flow supply line and/or in the process chamber.

42. The microfluidic system according to claim 30, wherein at least one second carrier flow output line is discharged from the process chamber.

43. The microfluidic system according to claim 42, wherein a sorting unit is arranged in a downstream area of the process chamber that sorts the particles into the first carrier flow output line or into the second carrier flow output line.

44. The microfluidic system according to claim 43, wherein the second carrier flow output line is discharged in a flow line behind the field cage from the process chamber and the second carrier flow output line is discharged from the processing chamber in a laterally offset manner.

45. The microfluidic system according to claim 44, wherein a third carrier flow output line is discharged from the process chamber, wherein the third carrier flow output line is discharged from the process chamber laterally offset opposite the flow line behind the field cage.

46. The microfluidic system according to claim 35, further comprising:
a selection unit arranged in the direction of flow between the measuring stations and the field cage that selects certain particles from the first carrier flow and/or from the second carrier flow and supply lines them to the field cage,
at least one centering unit that centers the particles and is arranged in the first carrier flow supply line and/or in the second carrier flow supply line and/or in the process chamber,
at least one holding unit that holds the particles and is arranged in the first carrier flow supply line and/or in the second carrier flow supply line and/or in the process chamber, and
a sorting unit arranged in a downstream area of the process chamber that sorts the particles into the first carrier flow output line or into a second carrier flow output line,
wherein the centering unit, the sorting unit, the selection unit or the holding unit has a dielectrophoretic electrode arrangement.

47. The microfluidic system according to claim 30, wherein a holding unit is arranged in at least one of the carrier flow output lines in order to intermediately store the particles in the output line.

48. A cell fusioner comprising a microfluidic system according to claim 30.

49. A cell sorter comprising a microfluidic system according to claim 30.

50. An operational method for a microfluidic system according to claim 1, said method comprising the following steps:
supplying of a first carrier flow with particles suspended therein by a first carrier flow supply line into a process chamber of the microfluidic system,
examination, observation, manipulation and/or selection of the particles in the process chamber, and
discharging of at least a part of the first carrier flow with the particles suspended therein via a first carrier flow output line,
wherein at least a second carrier flow with particles suspended therein is supplied by a second carrier flow supply line into the process chamber.

51. The operational method according to claim 50, further comprising the following steps:
examination of the particles suspended in the first carrier flow, and
examination of the particles suspended in the second carrier flow.

52. The operational method according to claim 51, further comprising selecting the particles suspended in the first carrier flow or of the particles suspended in the second carrier flow as a function of the examination of the particles suspended in the first carrier flow and/or as a function of the particles suspended in the second carrier flow.

53. The operational method according to claim 52, further comprising fixing the selected particles in a dielectrophoretic field cage.

54. The operational method according to claim 53, further comprising examination of the particles fixed in the field cage.

55. The operational method according to claim 50, further comprising sorting the particles into one of several carrier flow output lines.

56. The operational method according to claim 55, wherein the sorting takes place as a function of the examination of the particles fixed in the field cage.

57. The operational method according to claim 50, wherein the examination of the particles suspended in the first carrier flow and/or the examination of the particles suspended in the second carrier flow and/or the examination of the particles fixed in the field cage comprise(s) a transmitted-light measuring and/or a fluorescence measuring.

58. The operational method according to claim 50, wherein the centering unit and/or holding unit arranged in the first carrier flow supply line on one hand and the centering unit and/or holding unit arranged in the second carrier flow supply line on another hand are controlled in a time-coordinated manner.
